(19) United States
(12) Patent Application Publication
(10) Pub. No.: US 2025/0371231 A1
(43) Pub. Date: Dec. 4, 2025

(54) Apparatus and Method with Compact Model Processing

(71) Applicant: RESEARCH & BUSINESS FOUNDATION SUNGKYUNKWAN UNIVERSITY, Suwon-si (KR)

(72) Inventors: Jeong-Taek KONG, Seoul (KR); So Young KIM, Suwon-si (KR); Sang Min WOO, Incheon (KR); Hyun Joon JEONG, Suwon-si (KR); Jin Young CHOI, Suwon-si (KR); Hyung Min CHO, Suwon-si (KR)

(73) Assignee: RESEARCH & BUSINESS FOUNDATION SUNGKYUNKWAN UNIVERSITY, Suwon-si (KR)

(21) Appl. No.: 18/639,395

(22) Filed: Apr. 18, 2024

(30) Foreign Application Priority Data
Apr. 18, 2023 (KR) 10-2023-0050540

(51) Int. Cl. G06F 30/3308; G06N 3/08

(52) U.S. Cl. CPC G06F 30/3308; G06N 3/08

(57) ABSTRACT

An apparatus includes one or more processors configured to train an artificial neural network for an analysis target including at least one of a first artificial neural network corresponding to a current-voltage model and a second artificial neural network corresponding to a capacitance-voltage model by using a geometric parameter and a process parameter as an input value; and extract a compact model by determining any one or any combination of any two or more of a current-voltage model corresponding to the trained first artificial neural network and a capacitance-voltage model corresponding to the trained second artificial neural network based on an input value of an input layer, a weight of a hidden layer, a bias of the hidden layer, an output value of the hidden layer, an output value of the output layer, and an activation function obtained from the trained first and second artificial neural networks.

### CROSS-REFERENCE TO RELATED APPLICATIONS

The application claims the benefit under 35 USC § 119(a) of Korean Patent Application No. 10-2023-0050540, filed on Apr. 18, 2023, in the Korean Intellectual Property Office, the entire disclosure of which is incorporated herein by reference for all purposes.

### BACKGROUND

### 1. Field

The following description relates to an apparatus and a method with compact model processing.

### 2. Description of the Related Art

Semiconductor-based devices, such as integrated circuits, are produced through design and process. However, when the designed semiconductor-based device does not show desired electrical characteristics in an actual production process or operates differently from expected ones, it is almost impossible to correct the electrical characteristics in a process, which may result in redesigning the device from the beginning and then reproducing. Since such a redesign process may significantly increase the semiconductor manufacturing time and cost, it is common to design a compact model for a semiconductor before the actual production of the semiconductor and to perform a simulation (mock test) for the operation of the semiconductor based on the compact model. The compact model currently used is a mathematical expression of electrical characteristics or operations of respective circuit components of a semiconductor-based device so that a simulation for electrical characteristics of a corresponding device can be performed before a process.

In recent years, with the scaling of devices and high integration of semiconductor-based devices according to the introduction of nanotechnology and microprocesses, the demand for a compact model that can appropriately represent a designed semiconductor device or apparatus is increasing. However, as technology, processes, materials, or structures are changed according to the progress of scaling and high integration, a physical phenomenon that is difficult to describe frequently occurs, and accordingly, it is very difficult to develop and implement a compact model corresponding to a corresponding device. Therefore, the compact model corresponding to the developed next-generation device has been introduced only after several years have passed since the next-generation device was proposed, which has been a major cause of delay in the development of semiconductor devices. On the other hand, the compact model requires a high degree of expertise and a large amount of time to extract model parameters. Recently, a Berkeley short-channel IGFET Model (BSIM) model has been mainly used, and a very large number of model parameters of 1000 or more are used in the BSIM model, which is expected to further increase according to the scaling of the process. This point adds to the difficulty of developing and using compact models for next-generation devices. In addition, the complexity of the compact model due to the high integration and the increase in device complexity causes a decrease in the processing speed of the simulation. This is noticeable in experiments with large circuits or simulations with high computational costs, such as Monte Carlo simulations.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an apparatus includes one or more processors configured to train an artificial neural network for an analysis target including at least one of a first artificial neural network corresponding to a current-voltage model and a second artificial neural network corresponding to a capacitance-voltage model by using a geometric parameter and a process parameter as an input value; and extract a compact model by determining any one or any combination of any two or more of a current-voltage model corresponding to the trained first artificial neural network and a capacitance-voltage model corresponding to the trained second artificial neural network based on an input value of an input layer, a weight of a hidden layer, a bias of the hidden layer, an output value of the hidden layer, an output value of the output layer, and an activation function obtained from the trained first artificial neural network and the trained second artificial neural network.

The analysis target may include a field effect transistor having at least one channel. The process parameter may include a channel doping depth that is a depth at which ions are implanted into the field effect transistor channel.

The field effect transistor may include either one or both of a nanosheet FET and a negative capacitance nanosheet FET. The geometric parameter may include any one or any combination of any two or more of a gate length, a width of a nanosheet, a thickness of the nanosheet, a thickness of a spacer, and a thickness of a ferroelectric material of the nanosheet FET and the negative capacitance nanosheet FET.

The loss function of the artificial neural network is a weighted sum of a mean square of error between the measured value of the blocked region and the predicted value, a mean square of error between the measured value of the linear region and the predicted value, and a mean square of error between the measured value of the saturated region and the predicted value.

The one or more processors may be further configured to calculate any one or any combination of any two or more of at least one capacitance, at least one current, transconductance, and drain conductance and generate a compact model by combining either one or both of a current-voltage model corresponding to the trained first artificial neural network and a capacitance-voltage model corresponding to the trained second artificial neural network with any one or any combination of any two or more of the at least one capacitance, the at least one current, the transconductance, and the drain conductance.

The capacitance may include any one or any combination of any two or more of a gate capacitance, a gate-source capacitance, a gate-drain capacitance, and a gate-body capacitance. The one or more processors may calculate the capacitance by multiplying the number of fins by one output value among output values of the second artificial neural network.

The current may include any one or any combination of any two or more of a current between a gate and a drain, a current between a gate and a source, and a current between a gate and a body. The one or more processors may be configured to calculate the current based on a value obtained by multiplying the calculated capacitance by a variation of a voltage over time.

The apparatus may further include a simulator configured to perform a simulation for the analysis target based on the compact model.

The apparatus may further include a memory storing instructions, wherein the one or more processors may be configured to execute the instructions to configure the one or more processors to perform the training of the artificial neural network, and perform the extraction of the compact model.

In one or more general aspect, a processor-implemented method includes training an artificial neural network for an analysis target including either one or both of a first artificial neural network corresponding to a current-voltage model and a second artificial neural network corresponding to a capacitance-voltage model by using obtained geometric parameter and obtained process parameter as an input value to obtain at least one trained artificial neural network; and extracting a compact model by determining any one or any combination of any two or more of a current-voltage model corresponding to the trained first artificial neural network and a capacitance-voltage model corresponding to the trained second artificial neural network based on an input value of an input layer, a weight of a hidden layer, a bias of the hidden layer, an output value of the hidden layer, an output value of the output layer, and an activation function obtained from the trained first artificial neural network and the trained second artificial neural network.

The analysis target may include a field effect transistor having at least one channel, and the process parameter may include a channel doping depth that is a depth at which ions are implanted into the field effect transistor channel.

The field effect transistor may include either one or both of a nanosheet FET and a negative capacitance nanosheet FET. The geometric parameter may include any one or any combination of any two or more of a gate length, a width of a nanosheet, a thickness of the nanosheet, a thickness of a spacer, and a thickness of a ferroelectric material of the nanosheet FET and the negative capacitance nanosheet FET.

The loss function of the artificial neural network may be a weighted sum of a mean square of error between the measured value of the blocked area and the predicted value, a mean square of error between the measured value of the linear area and the predicted value, and a mean square of error between the measured value of the saturated area and the predicted value.

The extracting of the compact model may include calculating any one or any combination of any two or more of at least one capacitance, at least one current, transconductance, and drain conductance; and generating the compact model by combining either one or both of a current-voltage model corresponding to the trained first artificial neural network and a capacitance-voltage model corresponding to the trained second artificial neural network with any one or any combination of any two or more of the at least one capacitance, the at least one current, the transconductance, and the drain conductance.

The capacitance may include any one or any combination of any two or more of a gate capacitance, a gate-source capacitance, a gate-drain capacitance, and a gate-body capacitance. The extracting of the compact model may be configured to calculate the capacitance by multiplying the number of fins by any one output value among output values of the second artificial neural network.

The current may include any one or any combination of any two or more of a current between a gate and a drain, a current between a gate and a source, and a current between a gate and a body. The extracting of the compact model may be configured to calculate the current based on a value obtained by multiplying the calculated capacitance by a variation of a voltage over time.

The transconductance may be an amount of current change between a source and a drain according to a change in voltage between the source and the gate, and the drain conductance may be an amount of current change between the source and the drain according to a change in voltage between the source and the drain.

The method may further include performing a simulation for the analysis target based on the compact model.

A non-transitory computer-readable storage medium may store instructions that, when executed by the one or more processors, configure the one or more processors to perform any of the methods herein.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### BRIEF DESCRIPTION OF THE DRAWINGS

FIG. 1 is a schematic diagram of a compact model processing apparatus according to an embodiment.

FIG. 2A is a diagram illustrating an example of an analysis target.

FIG. 2B is a diagram showing an example of physical/mathematical parameter values.

FIG. 3 is a view of a first artificial neural network according to an embodiment.

FIG. 4 is a view of a second artificial neural network according to an embodiment.

FIG. 5 is a first pseudo code for the model designer according to an embodiment.

FIG. 6 is a second pseudo code for the model designer according to an embodiment.

FIG. 7 is a diagram showing circuit simulation results of the compact model processing apparatus according to an embodiment and the conventional BSIM-based simulation apparatus for a nanosheet FET.

FIG. 8 is a table illustrating circuit simulation results of a compact model processing apparatus and a conventional BSIM-based simulation apparatus with respect to a nanosheet FET.

FIG. 9 is a graph illustrating an example of a C-V curve obtained according to a plurality of process parameters.

FIG. 10 is a graph illustrating comparison results between transient simulation results of a compact model processing apparatus according to an embodiment and a ring oscillator according to the related art.

FIG. 11 is a graph illustrating a comparison between simulation results of a compact model processing apparatus according to an embodiment and a five transistor OTA according to the related art.

FIG. 12 is a diagram illustrating a comparison result of simulation processing times by the compact model processing apparatus according to an embodiment and the related art.

FIG. 13 is a view illustrating a comparison result of simulation processing times by the compact model processing apparatus according to an embodiment and the related art in the form of a graph.

FIG. 14 is a graph illustrating on-current distribution according to a channel doping depth.

FIG. 15 is a flowchart of a compact model processing method according to an embodiment.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment, e.g., as to what an example or embodiment may include or implement, means that at least one example or embodiment exists where such a feature is included or implemented, while all examples are not limited thereto.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Due to manufacturing techniques and/or tolerances, variations of the shapes shown in the drawings may occur. Thus, the examples described herein are not limited to the specific shapes shown in the drawings, but include changes in shape that occur during manufacturing.

Unless otherwise defined, all terms, including technical and scientific terms, used herein have the same meaning as commonly understood by one of ordinary skill in the art to which this disclosure pertains specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

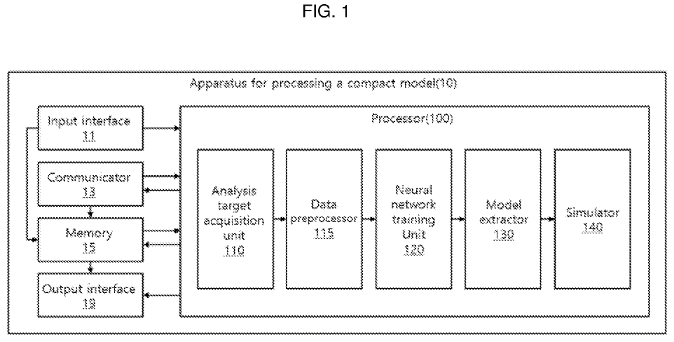

Hereinafter, an embodiment of an apparatus for processing a compact model will be described with reference to FIGS. 1 to 6.

FIG. 1 is a schematic diagram of an apparatus for processing a compact model according to an embodiment.

Referring to FIG. 1, an apparatus for processing a compact model 10 according to an embodiment may include an input interface 11, a communicator 13, a memory 15, an output interface 19, and a processor 100. Here, at least two of the input interface 11, the communicator 13, the memory 15, the output interface 19, and the processor 100 are provided to transmit data, commands/instructions, or the like to one or both sides through a circuit line, a cable, a wireless communication network, or the like. At least one of the input interface 11, the communicator 13, the memory 15, and the output interface 19 may be omitted according to an embodiment.

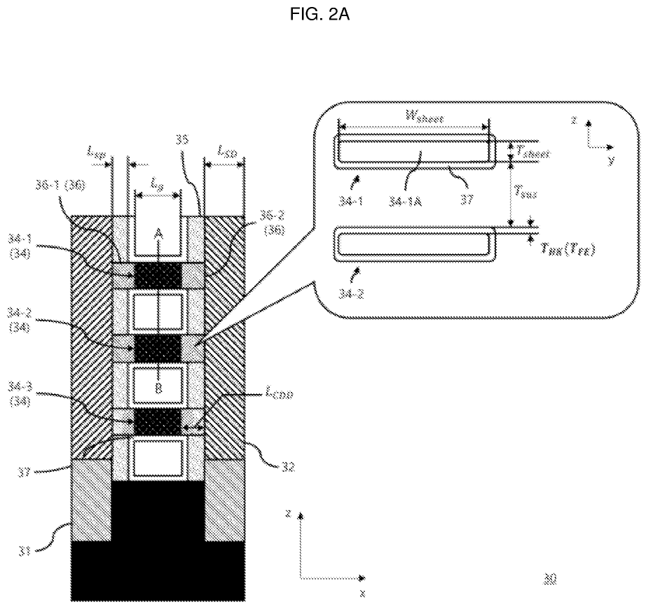

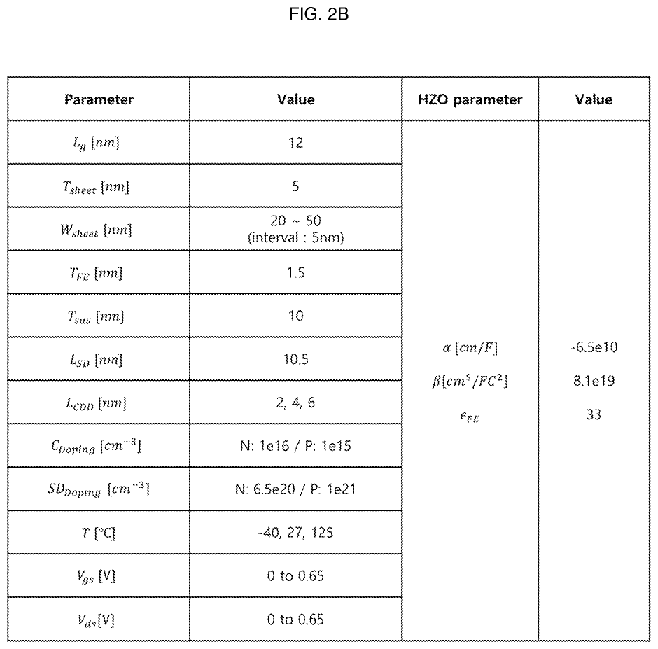

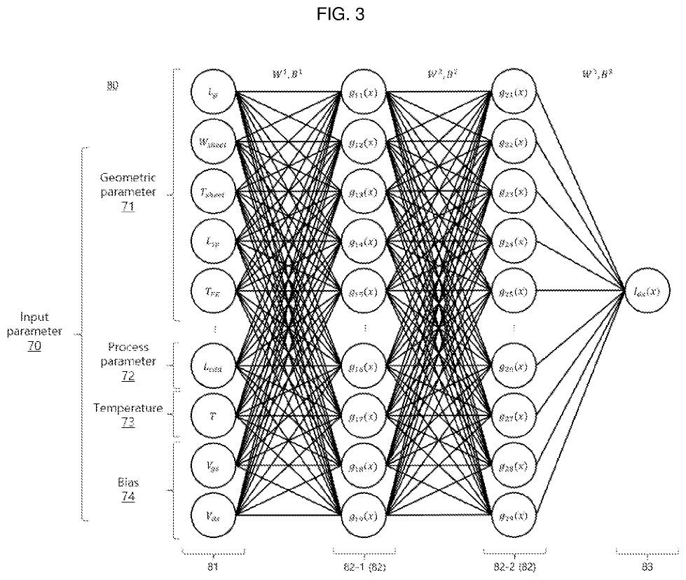

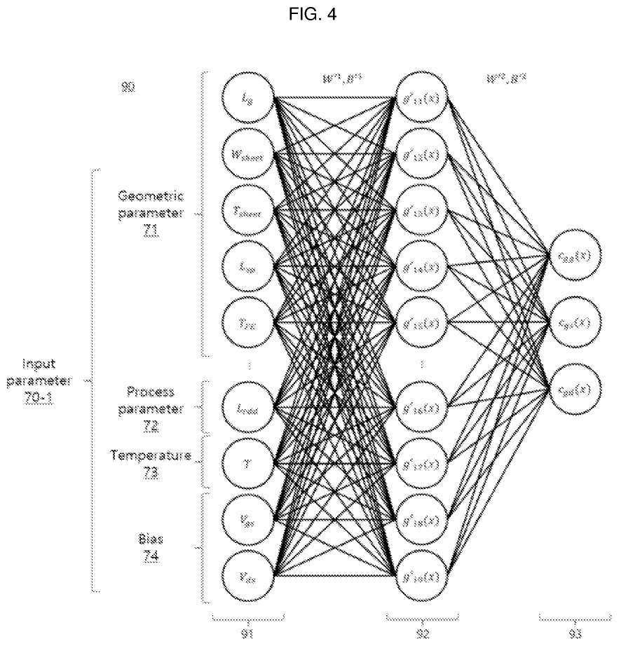

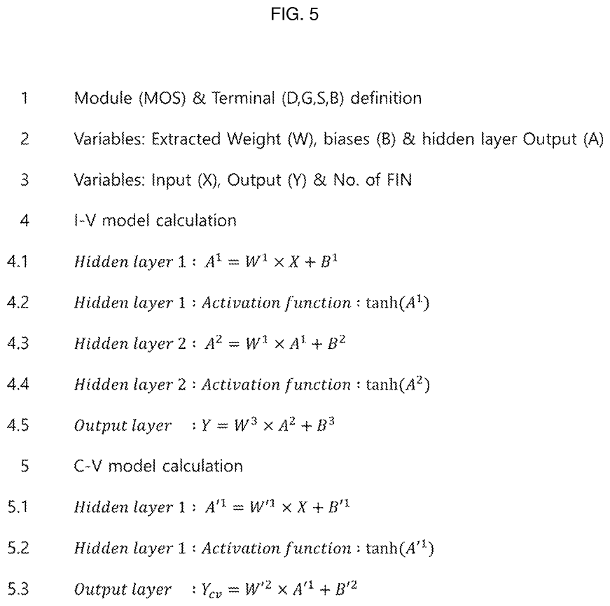

The input interface 11 may receive data, commands/instructions, or programs (which may be referred to as apps, applications, or software) desired for the operation of the apparatus for processing a compact model 10 from the outside. Here, the data desired for the operation of the apparatus for processing a compact model 10 may include, for example, information about the analysis target (30 in FIG. 2A) or information about the artificial neural network (80 in FIG. 3, 90 in FIG. 4, etc.). The analysis target may mean an actual or virtual object to be implemented as a compact model, and may include a semiconductor device or an integrated circuit according to an embodiment. According to an embodiment, the semiconductor device may include a Field Effect Transistor (FET). The field effect transistor may be implemented to include a source (for example, 31 in FIG. 2A), at least one channel (for example, 34 in FIG. 2A), a drain (for example, 32 in FIG. 2A), and a gate, and may include, for example, a MOSFET (Metal-Oxide-Semiconductor FET), a FinFET, a GAAFET (Gate All Around FET), a NSFET (NanoSheet FET) (30 in FIG. 2A), or a NC-NSFET (Negative Capacitance NSFET). However, the analysis target is not limited thereto. Depending on the user or designer, these and other semiconductor devices may be used as analysis targets. The information on the analysis target may include information on the size (the size of each portion constituting the semiconductor device, etc.), structure, or configuration of the semiconductor device to be analyzed, and/or may include information on a device included in the integrated circuit to be analyzed or a structure thereof. This will be described later with reference to FIGS. 2A and 2B. The information on the analysis target may be used as an input parameter (70 in FIGS. 4 and 70-1 in FIG. 5) of the artificial neural network 80 and 90. The information on the artificial neural network 80 and 90 may include, for example, the size (the number of nodes or layers, etc.) of the artificial neural network 80 and 90. However, the information on the analysis target and/or the information on the artificial neural network 80 and 90 are not limited to the above description, and may include other information or parameters in addition or instead of the above depending on the designer or the user. The input interface 11 may be implemented using, for example, a keyboard, a mouse, a tablet input device, a touch screen, a touch sensor, a microphone, a data input/output module, an image photographing module, a motion detection sensor, a pressure sensor, a proximity sensor, or the like.

The communicator 13 may be communicably connected to another external device through a wired or wireless communication network, and may receive data, commands/instructions, programs, or the like desired for the operation of the apparatus for processing a compact model 10 from another external device. In addition, the communicator 13 may transmit the compact model acquired according to training, the parameter(s) or the simulation result acquired from the compact model, or the like to another external device. Accordingly, the user may access the apparatus for processing a compact model 10 through a terminal (e.g., a smartphone, a desktop computer, or the like) to provide information to the apparatus for processing a compact model 10, input a command related to generating a compact model, or acquire a processing result of the apparatus for processing a compact model 10. The communicator 13 may be implemented using a LAN card or a wireless communication module.

The apparatus for processing a compact model 10 may be a terminal. As a non-exhaustive example only, a terminal as described herein may be a mobile device, such as a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, a high-definition television (HDTV), a DVD player, a Blu-ray player, a set-top box, or a home appliance, or any other mobile or stationary device configured to perform wireless or network communication. In one example, a wearable device is a device that is designed to be mountable directly on the body of the user, such as a pair of glasses or a bracelet. In another example, a wearable device is any device that is mounted on the body of the user using an attaching device, such as a smart phone or a tablet attached to the arm of a user using an armband, or hung around the neck of the user using a lanyard.

The storage 15 may temporarily or non-temporarily store data or an artificial neural network obtained through the input interface 11 or the communicator 13 or obtained during the processing of the processor 100. For example, the memory 15 may store information on an analysis target or a parameter to be input to the artificial neural network, provide the artificial neural network to be trained and the parameter 70 to the processor 100 according to a call of the processor 100, receive and store a compact model obtained by the processor 100 or a parameter corresponding to the corresponding compact model, or provide all or part of a processing result of the processor 100 to the processor 100 again. In addition, the memory 15 may store a program for performing an operation of the apparatus for processing a compact model 10, and the program stored in the memory 15 may be directly written or modified by a designer such as a programmer and then stored in the memory 15, may be received from another physical recording medium and stored, and/or may be obtained or updated through an electronic software distribution network accessible through a wired/wireless communication network. The memory 15 may be implemented using at least one of a main memory device and an auxiliary memory device according to an embodiment.

The output interface 19 may output a processing result of the processor 100 or data stored in the memory 15 to the outside. For example, the output interface 19 may visually or audibly output a compact model acquired by training, parameter(s) corresponding to the compact model, a simulation result based on the compact model, or the like to the outside. The output interface 19 may be implemented using, for example, a display, a printer device, a speaker device, an image output terminal, or a data input/output terminal, but is not limited thereto.

The processor 100 is provided to perform operations such as various operation processing or control related to the compact model. For example, the processor 100 may be configured to sequentially or simultaneously perform at least one operation of a generation operation of an analysis target, a training operation of the artificial neural network 80 and 90, an operation of acquiring a compact model, and a simulation training operation. More specifically, for example, the processor 100 may generate an analysis target by a user's manual operation or automatically as predefined based on information of at least one of the input interface 11, the communicator 13, and the memory 15 (hereinafter, referred to as the input interface 11 etc.), or acquire information on the artificial neural network 80 and 90 from the input interface 11, the communicator 13, and the memory 15 to construct at least one artificial neural network 80 and 90. In addition, the processor 100 may obtain the parameter 70 to be input to the artificial neural network 80 and 90 and train the artificial neural network 80 and 90 based thereon, generate a compact model corresponding to the artificial neural network 80 and 90, and/or perform simulation using the parameter extracted from the compact model. Each of these operations will be described later. In addition, according to the embodiment, the processor 100 may control the overall operation of the apparatus for processing a compact model 10 by executing a program stored in the memory 15. The processor 100 may be implemented using, for example, one or more of a Central Processing Unit (CPU), a Graphic Processing Unit (GPU), a Micro Controller Unit (MCU), an Application Processor (AP), an Electronic Controlling Unit (ECU), or other electronic devices capable of performing the above-described operations.

The processor 100, according to an embodiment, may include an analysis target acquisitor 110, a data preprocessor 115, a neural network trainer 120, a model extractor 130, and a simulator 140. Here, at least two of the analysis target acquisitor 110, the data preprocessor 115, the neural network trainer 120, the model extractor 130, and the simulator 140 may be logically or physically distinguished according to embodiments. In addition, at least one of the analysis target acquisitor 110, the data preprocessor 115, the neural network trainer 120, the model extractor 130, and the simulator 140 may be omitted according to arbitrary selection of a designer or a user. For example, the simulator 140 may be omitted, and in this case, the apparatus for processing a compact model 10 may output the model acquired by the model extractor 130 or the parameter thereof to the outside through the communicator 13 or the output interface 19 to transfer the model or the parameter thereof to another device in which the simulator 140 is provided, and another device in which the simulator 140 is provided may perform the simulation based on the model or the parameter transferred in response to the transfer of the model or the parameter.

FIG. 2A is a diagram illustrating an example of an analysis target. Specifically, FIG. 2A is a view of the nanosheet FET, which is a cross-sectional view of the nanosheet FET based on a Y-axis, and the view in the square of FIG. 2A is a cross-sectional view of the nanosheet FET taken along line A-B based on an X-axis.

The analysis target acquisitor 110 may acquire the analysis target according to manual operation or automatically based on information provided by a user or a designer. Here, the analysis target may include, for example, the nanosheet FET 30, as shown in FIG. 2A, and the information provided by the user or the designer may include information about the nanosheet FET 30. The information about the nanosheet FET 30 may include, for example, one or more of the overall structure of the nanosheet FET 30, each portion within the overall structure, a width, a depth, or an area of each portion, and/or a value for a material of each portion, and the like. The information of the nanosheet FET 30 may be obtained from at least one of the input interface 11, the communicator 13, and the memory 15 via a circuit, a cable, or a wireless communication network, according to an embodiment. At least one of the pieces of information of the nanosheet FET 30 may be used as input parameter 70 and 70-1, as described below. When the information about the nanosheet FET 30 is acquired, the analysis target acquisitor 110 may acquire the corresponding nanosheet FET 30 in a two-dimensional or three-dimensional form by combining the given information about the nanosheet FET 30. Hereinafter, in describing the operations of the apparatus for processing a compact model 10 and the processor 100, the nanosheet FET 30 uses an embodiment to be analyzed, but this is merely an example. In another embodiment, the analysis target may be a negative capacitance nanosheet FET, or may be a homogeneous or heterogeneous semiconductor device. When the negative-capacitance nanosheet FET or another semiconductor device is an analysis target, the processor 100 may operate the same as or at least partially different from the case in which the nanosheet FET 30 is the analysis target, according to an embodiment. The analysis target acquisitor 110 may be omitted.

Referring to FIG. 2A, the nanosheet FET 30 may include a source (hereinafter, referred to as an I source) 31, a drain (hereinafter, referred to as a drain) 32, and channels 34 (34: 34-1, 34-2, and 34-3) providing a transfer path of electrons between the source 31 and the drain 32 (a gate is not shown).

The source 31 and the drain 32 may be disposed to face each other, extend in the z-axis direction, and have the shape of a plate with a predetermined thickness L_SD in the x-axis and y-axis directions. The channels 34 (34-1, 34-2, and 34-3) are disposed between the source 31 and the drain 32, and one or more channels may be provided according to an embodiment. When the plurality of channels 34 (34-1, 34-2, and 34-3) are provided, the at least two channels 34-1 and 34-2 may be spaced apart from each other by a predetermined distance (T_sus, interval). The intervals between the plurality of channels 34 (34-1, 34-2, and 34-3) may be all the same, or all or some of the intervals may be different according to an embodiment. Each of the channels 34 (34: 34-1, 34-2, and 34-3) may include one or more nanosheets 34-1A having a predetermined width (W_sheet, length in the y direction) and a thickness (T_sheet, length in the z direction). Electrons move from the source 31 to the drain 32 through the nanosheet 34-1A.

A channel doping area 36 (36-1 and 36-2) may exist in at least one of between the source 31 and the at least one channel 34 (34-1, 34-2, and 34-3) and between the drain 32 and the at least one channel 34 (34-1, 34-2, and 34-3). The channel doping area 36 (36-1 and 36-2) may be formed at the end of the channel 34 (34-1, 34-2, and 34-3) in the direction of the source 31 and the end of the channel 34 (34-1, 34-2, and 34-3) in the direction of the drain 32, respectively, in the longitudinal direction of the channel 34 (34-1, 34-2, and 34-3). The length of each channel doping region 36 (36-1 and 36-2) in the y-axis direction represents an L_CDD (hereinafter, referred to as a channel doping depth) to which a channel is doped. The channel doping depth L_CDD refers to a depth at which ions are implanted into each of the channels 34 (34-1, 34-2, and 34-3). In general, as the depth to which ions are implanted increases, the channel capacitance decreases, and the current flowing along each channel 34 (34-1, 34-2, 34-3) correspondingly decreases. Therefore, the channel doping depth L_CDD is one variable that determines the electrical performance of the nanosheet FET 30. The channel doping depth L_CDD may be the same for each of the channels 34 (34: 34-1, 34-2, and 34-3), may be different for some of the channels 34 (34: 34-1, 34-2, and 34-3), or may be different for all of the channels 34 (34: 34-1, 34-2, and 34-3). Depending on the situation, the channel doping depth L_CDD may be smaller than the thickness L_sp of the spacer 35.

A ferroelectric (FE) material 37 may be further formed on the nanosheet 34-1A of the channel 34. The ferroelectric material 37 may be provided to surround the nanosheet 34-1A in the form of an oxide film, and for example, may be provided to be applied to the upper surface and/or the lower surface of the nanosheet 34-1A or to both sides (front and rear surfaces and/or both side surfaces) of the x-axis direction and/or the y-axis direction. The ferroelectric material 37 may be formed on the nanosheet 34-1A to a predetermined thickness (T_FE, which may include a thickness of an oxide film, In the case of NSFET, high-K material is used as insulator material, it can be expressed as T_HK). If the analysis target is the nanosheet FET 30, the ferroelectric material 37 may be implemented using hafnium oxide (HfO2). If the analysis target is a negative capacitance-nanosheet FET, the ferroelectric material 37 may be implemented using a HfO2-ZrO2 solid solution (HZO) instead of hafnium oxide (HfO2).

A spacer 35 having a predetermined thickness L_sp may be formed on one side of the source 31 in a direction toward the drain 32. Similarly, the spacer 35 having the same or different thickness L_sp may be formed on one side of the drain 32 in the source direction 31. Each spacer 35 may be implemented using an insulator. A gate may be installed in a space provided between the spacers 35, and may have a predetermined width L_g (hereinafter, referred to as a gate length) in the y-axis direction. The gate length L_g may be greater than, less than, or equal to the length of each channel 34 (34: 34-1, 34-2, 34-3).

FIG. 2B is a diagram showing an example of physical/mathematical parameter values.

At least one of the z-axis directional interval T_sus between the at least two channels 34-1 and 34-2, the width W_sheet of the nanosheet 34-1A, the thickness T_sheet of the nanosheet 34-1A, the channel doping depth L_CDD, the thickness T_FE (e.g., the thickness of the oxide film) of the ferroelectric material 37, the thickness L_SD of the source 31 or the drain 32, and the gate length L_g may be input by a user or a designer using the input interface 11 or the communicator 13. These values may be given, for example, as shown in FIG. 2B. Referring to FIG. 2B, the gate length L_g may be 12 nm, the thickness T_sheet of the nanosheet 34-1A may be 5 nm, the width W_sheet of the nanosheet 34-1A may be 20 to 50 nm, the thickness T_FE of the ferroelectric material 37 may be 1.5 nm, the interval T_sus between the two channels 34-1 and 34-2 may be 10 nm, and the thickness L_SD of the source 31 or the drain 32 may be 10.5 nm. The channel doping depth L_CDD may be determined as at least one of 2 nm, 4 nm, and 6 nm. In the case of doping values of the channels 34 (34-1, 34-2, and 34-3), N may be given as 1e16, and P may be given as 1e15. Regarding the doping value for the source 31 or the drain 32, N may be given as 6.5e20, and P may be given as 1e21. Meanwhile, when the ferroelectric material 37 is used, the respective values α, β, and ε_FE for the HfO2-ZrO2 solid solution may be determined as −6.5e10 cm/F, 8.1e19 cm\hat{ }5/FC\hat{ }2, and 33, respectively. However, these values are, and the designer or the user may define all or some of these values differently from those described above according to arbitrary selection.

When these values are input, the analysis target acquisitor 110 may virtually generate an analysis target, for example, the nanosheet FET 30, based on the input value, and transmit the generation result to at least one of the data preprocessor 115 and the neural network trainer 120.

The data preprocessor 115 may perform data preprocessing on the obtained information to obtain the input parameter 70 and 70-1 to be input to the artificial neural network. For example, the data preprocessor 115 may perform data preprocessing on the information on the analysis target designed by the analysis target acquisitor 110 or the analysis target provided from the user through the input interface 11. Here, the data preprocessing may include, for example, data scaling, and the data scaling may include at least one of min-max scaling applied to an input value and logarithmic scaling applied to an output value. The value preprocessed by the data preprocessor 115 may be transmitted to the neural network trainer 120. The data preprocessor 115 may be omitted according to an embodiment.

FIG. 3 is a view of a first artificial neural network according to an embodiment, and FIG. 4 is a view of a second artificial neural network according to an embodiment.

The neural network trainer 120 may train at least one artificial neural network 80 or 90 (hereinafter, referred to as a first artificial neural network and a second artificial neural network, respectively) as shown in FIGS. 3 and 4, based on data transmitted from the input interface 11 or the like or transmitted from at least one of the data designer 110 and the data preprocessor 115. Here, the training for the at least one artificial neural network 80 or 90 may be performed using all the transmitted data, or may be performed using some of the transmitted data. In the latter case, data not used for training may be used as verification data for the artificial neural network 80 and 90. The training of the artificial neural network 80 and 90 may be repeated at least once or more. For example, the training of the artificial neural network 80 and 90 may be performed at approximately 200,000 epochs. According to an embodiment, as shown in FIGS. 3 and 4, the neural network trainer 120 may perform training on two artificial neural networks, that is, the first artificial neural network 80 and the second artificial neural network 90. The first artificial neural network 80 may correspond to a current-voltage model (I-V model) to be described later, and the second artificial neural network 90 may correspond to a capacitance-voltage model (C-V model). The above the artificial neural network 80 and 90 may be trained independently or dependently according to the selection of a user or a designer, and may be sequentially or simultaneously performed according to situations. Training of at least one of the first artificial neural network 80 and the second artificial neural network 90 may be performed using corresponding the input parameter 70 and 70-1 and the output value Ids (x), c_gg(x), c_gs(x), and c_gd(x), as described below. The at least one artificial neural network 80 and 90 used for training may include a Deep Neural Network (DNN), a Convolutional Neural Network (CNN), a Convolutional Recurrent Neural Network (CRNN), a multi-layer perceptron, a Deep Belief Network (DBN), deep Q-networks, or the like, according to an embodiment. However, the artificial neural network trainable by the neural network trainer 120 is not limited thereto.

The at least one artificial neural network 80 and 90 described above may be expressed, for example, as in Equation 1 below.

$$Y = ( {W}^{layer} \times X ) + {B}^{layer} \qquad Equation 1$$

In Equation 1, Y denotes a value of the output layer 83 or 93, W\hat{ }layer denotes a weight of a specific layer, X denotes a value (70: 71, 72, 73, 74) input to the input layer 81 or 91, and B\hat{ }layer denotes deflection. Meanwhile, the loss function may be implemented using a mean square error or a cross entropy error. According to an embodiment, the loss function may be given as shown in Equation 2 below.

$$E = \frac{1}{n} {\sum }_{i = 1}^{n} ( {α ( {y}_{true , off -} {y}_{pred , off} )}^{2} + {β ( {y}_{true , lin} - {y}_{pred , lin} )}^{2} + {γ ( {y}_{true , sat} - {y}_{pred , sat} )}^{2} ) \qquad Equation 2$$

In Equation 2, y_true. Off, y_true. Lin and y_true. Sat are ground truth values for a blocking region, a linear region and a saturation region, respectively, and y_pred. off, y_pred. lin and y_pred. sat are predicted values for a block region, a linear region, and a saturation region, respectively. A, β, and γ are weights. The α may be used to determine how much the difference between the measured and predicted values for the blocked region is reflected, and the β may be used to determine how much the difference between the measured and predicted values for the linear region is reflected. In addition, the γ may be used to determine how much the difference between the measured and predicted values for the saturation region is reflected. That is, the loss function may be given as the weighted sum of each of the mean square of error between the measured value and the predicted value of the blocking region, the mean square of error between the measured value and the predicted value of the linear region, and the mean square of error between the measured value and the predicted value of the saturation region. Here, the weights α, β, and γ may be arbitrarily determined according to a designer or a user's selection. At least one of the weights α, β, and γ may be set to 0 according to circumstances. In a simulator such as SPICE, DC simulation, AC simulation, transient simulation or Monte Carlo simulation may be performed. In this case, in order for the analog circuit to properly operate in the corresponding simulation, the accuracy of a gradient component in a saturation region is very important. In other words, high accuracy for the saturation region may be desired. If the loss function is given as shown in Equation 2, the accuracy of the saturation region may be further improved by appropriately adjusting the weight γ with respect to the saturation region. Accordingly, the overall performance of the simulation for the compact model may be further improved.

The at least one input parameter 70 or 70-1 may be used as an input value for each of the first artificial neural network 80 and the second artificial neural network 90. The input parameter 70 used as an input value in the first artificial neural network 80 and the input parameter 70-1 used as an input value in the second artificial neural network 90 may be the same as each other, or may be partially or entirely different from each other. The at least one input parameter 70 or 70-1 may be transmitted from the input interface 11, the data designer 110, or the data preprocessor 115 as described above.

According to an embodiment, at least one of the input parameter 70 and 70-1 for the first artificial neural network 80 and/or the second artificial neural network 90 may include at least one geometric parameter 71. The geometric parameter 71 is a parameter for the structure of the analysis target, and may include a length, a thickness, a width, and the like of at least one element 31, 32, 34, 35, 36, and the like of the analysis target. According to an embodiment, the geometry parameter 71 may include five key parameters. Here, the five key parameters may include, for example, a gate length L_g, a width W_sheet of the nanosheet 34-1A, a thickness T_sheet of the nanosheet 34-1A, a thickness L_sp of the spacer 35, and a thickness T_FE of the ferroelectric material 37. In some embodiments, only these five key parameters L_g, W_sheet, T_sheet, L_sp, and T_ox may be used as the geometry parameter 71. Even when training is performed using only five key parameters as the geometric parameter 71, the artificial neural network has a high accuracy of 98% or more. Therefore, training the artificial neural network 80 and 90 based on only the five key parameters L_g, W_sheet, T_sheet, L_sp, and T_ox may obtain a high-accuracy simulation result while reducing the dimension of the input number, thereby obtaining an effect of reducing the overall resource demand and shortening the training time.

At least one of the input parameter 70 for the first artificial neural network 80 and the input parameter 70-1 for the second artificial neural network 90 may further include a process parameter 72 in an embodiment. The process parameter 72 is a process-based variable that cannot be defined in a compact model based on a physical and mathematical equation such as BSIM-CMG. When the process parameter 72 is used as an input value, the performance of the semiconductor device 30 may be more quickly and accurately predicted, and the compact model may have scalability. According to an embodiment, the process parameter 72 may include a channel doping depth L_CDD. The channel doping depth L_CDD is a depth to which ions are implanted as described above, and a channel capacitance and a current are changed according to a length thereof. The channel doping depth L_CDD may have at least one of 2, 4, and 6 as its value, but is not limited thereto. A designer or a user may adjust a value of the channel doping depth L_CDD as necessary and use the adjusted value as an input value.

The input parameter 70 and 70-1 may further include a temperature 73 as desired. The temperature 73 refers to a temperature of an analysis target, for example, the nanosheet FET 30. As the temperature 73, at least one value in a range of approximately minus 40 degrees to 125 degrees for an image may be used. For example, as shown in FIG. 2B, a temperature 73 value of at least one of −40 degrees (−40), image 27 degrees 27, and image 125 degrees 125 may be input to at least one of the first artificial neural network 80 and the second artificial neural network 90. However, the temperature 73 is not limited thereto, and the value thereof may be adjusted by a designer or a user as necessary.

In addition, according to an embodiment, the input parameter 70 and 70-1 may further include at least one bias voltage 74. The bias voltage 74 may include at least one of a voltage V_ds (hereinafter, referred to as a drain-source voltage) between the source 31 and the drain 32 and a voltage V_gs (hereinafter, referred to as a gate-source voltage) applied to the gate. Since analog circuits can be better modeled by adding more voltage bias data than digital circuits, the selection of an appropriate voltage bias may be desired. Accordingly, at least one of the drain-source voltage V_ds and the gate-source voltage V-gs may have a value between 0 V and 0.65V as shown in FIG. 2B, and the drain-source voltage V-ds may be defined as a value of at least one of 0.05V, 0.325V, and 0.65V, and the gate-source voltage V-gs may be defined as a value of at least one of 0.05V, 0.25V, 0.325V, 0.5V, and 0.65V. According to an embodiment, the drain-source voltage and/or the gate-source voltage may be defined as different values from these.

The first artificial neural network 80 for the current-voltage model uses the current Ids (x) transmitted to the drain 32 when a voltage is applied as an output value of the output layer 83. Referring to FIG. 3, the first artificial neural network 80 may include an input layer 81, a hidden layer 82, and an output layer 83. The input layer 81 is a layer to which the geometry parameter 71, the process parameter 72, the temperature 73, and the bias voltage 72 are input. The hidden layer 82 may have multiple hidden layers, e.g., two hidden layers 82-1 and 82-2. Each of the hidden layers 82-1 and 82-2 may apply predetermined weights W\hat{ }1, W\hat{ }2, W\hat{ }3 and deflections B\hat{ }1, B\hat{ }2, B\hat{ }3 to the received value, and then transmit the resultant value to a next layer (e.g., the next hidden layer 82-2 or the output layer 83). Each of the hidden layers 82-1 and 82-2 may include at least one node, for example, 10 nodes g_11(x) to g_29(x), connected to each of the other layers 81, 82-1, 82-2, and 83. In some embodiments, each of the nodes g_11(x) to g_29(x) may use, as the activation function, a hyperbolic tangent function, a step function, a sigmoid function, or a ReLU function. As described above, the output layer 83 may have the value of the current Ids (x) when the gate voltage is applied.

The second artificial neural network 90 for the capacitance-voltage model may use the capacitances c_gg(x), c_gs(x), and c_gd(x) as a value of the output layer 93. Specifically, referring to FIG. 4, in an embodiment, the second artificial neural network 90 may include an input layer 91, a hidden layer 92, and an output layer 93. As described above, the input layer 91 is a layer to which the geometric parameter 71, the process parameter 72, the temperature 73, and the bias voltage 74 are input. The hidden layer 92 may apply predetermined weights W′\hat{ }1 and W′\hat{ }2 and deflections B′\hat{ }1 and B′\hat{ }2 to the received value (e.g., the input parameter 70-1), and then transfer the same to the next layer (e.g., the output layer 93). The hidden layer 92 may include at least one node connected to other layers 91 and 93, for example, ten nodes g′_11(x) to g′_19(x). The activation function of each of the nodes g′_11(x) to g′_19(x) may include, for example, a hyperbolic tangent function, a sigmoid function, a step function, a ReLU function, or the like. The output layer 93 may have at least one capacitance c_gg(x), c_gs(x), and c_gd(x) as an output value. Here, the at least one capacitance may include, for example, at least one of a capacitance c_gg(x) of the gate, a capacitance c_gs(x) between the gate and the source 31, and a capacitance c_gd(x) between the gate and the drain 32.

According to an embodiment, the neural network trainer 120 may be provided to generate at least one of the artificial neural networks 80 and 90 to be trained before the training of the artificial neural network 80 and 90. The generation of the artificial neural network 80 and 90 may be performed using information about the artificial neural network 80 and 90 transmitted from the input interface 11, etc. For example, the neural network trainer 120 may generate the first artificial neural network 80 based on the number of nodes or the number of layers for the first artificial neural network 80 transmitted from the input interface 11, etc., and generate the second artificial neural network 90 based on the number of nodes or the number of layers corresponding to the second artificial neural network 90 transmitted from the input interface 11, etc.

In addition, according to an embodiment, the neural network trainer 120 may be designed to perform verification of the trained artificial neural network 80 and 90 in a process of performing training for the artificial neural network 80 and 90 or after the training for the artificial neural network 80 and 90 is completed. In other words, the neural network trainer 120 may determine the accuracy of the artificial neural network 80 and 90. If it is determined that the artificial neural network 80 and 90 is not suitable as a result of the verification, the neural network trainer 120 may regenerate or retrain the artificial neural network. The regeneration may be performed using information other than the previously input information about the artificial neural network 80 and 90, and the other information may be newly input by a user or the like. During retraining, information on the existing analysis target may be used again, or information newly input from the user may be used.

The trained artificial neural network 80 and 90 itself or at least one piece of information (e.g., a weight or a bias) about the trained artificial neural network 80 and 90 may be transmitted to the model extractor 130.

According to an embodiment, the model extractor 130 may extract and obtain at least one compact model corresponding to the trained artificial neural network 80 and 90 using the trained artificial neural network 80 and 90. For example, the model extractor 130 may automatically extract a desired parameter from the trained artificial neural network 80 and 90, generate a code using the extracted parameter, and generate at least one compact model. Here, the compact model may include at least one of a current-voltage model corresponding to the first artificial neural network 80 and a capacitance-voltage model corresponding to the second artificial neural network 90. The generation of the compact model may be implemented based on, for example, a Verilog-A language, but is not limited thereto.

According to an embodiment, the model extractor 130 may be implemented using a vectorization technique. That is, the model extractor 130 may be designed to exclude as many or as few repetitive instructions (for, etc.) or condition instructions (if, etc.) that require relatively large resources and time as possible so that as many operations as possible may be performed on a plurality of data with one instruction. In addition, the model extractor 130 may be provided to use only the variable without using the array when storing or processing the weight or the deflection in order to generate the compact model. Since arrays usually use indexing, access and processing are inevitably delayed than variables. Accordingly, if variables are used instead of arrangement, the memory access speed or processing speed is improved to reduce the overall runtime. Meanwhile, in order to prevent an unnecessary variable in the code from occupying the memory space, the model extractor 130 may be implemented by minimizing the number of variables.

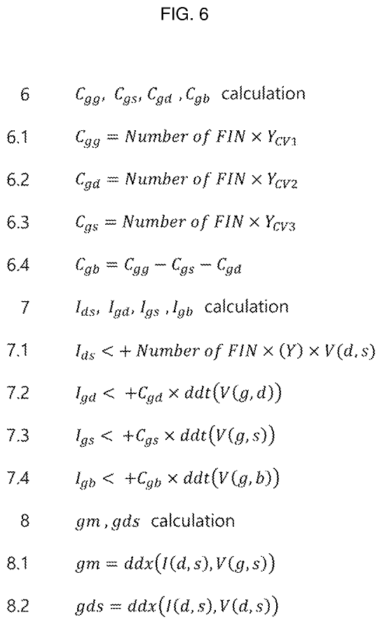

Hereinafter, a process of obtaining a compact model based on the artificial neural network 80 and 90 will be described in more detail with reference to FIGS. 5 and 6.

FIGS. 5 and 6 are a first pseudo code and a second pseudo code for the model designer according to an embodiment, respectively, and are pseudo codes of programming code implemented based on the Verilog-A language, respectively.

Referring to FIG. 5, in order to obtain a compact model, the model extractor 130 may first determine an analysis target (for example, a semiconductor device such as a nanosheet FET or a negative capacitance nanosheet FET) and a structure of the analysis target (for example, a terminal such as a source 31, a drain 32, a gate terminal, and a body (bulk)) (line 1). The analysis target and its structure may be transferred from the input interface 11 or the like, or may be transferred from the analysis target acquisitor 110, depending on the embodiment.

At least one variable to be used by the model extractor 130 is declared (lines 2 and 3). The declared variable may include, for example, a variable for the weight W, the bias B, and the output value of the hidden layers 82-1, 82-2, and 92 extracted from the trained artificial neural network 80 and 90 (second line), and may also include a variable for each of the input value X (e.g., the input parameter 70) and a variable for each of the output value Y (e.g., the current Ids (x)), the capacitances c_gg(x), c_gs(x), c_gd(x), and the like (third line). In addition, a variable for the number of fins of a semiconductor device (e.g., a FinFET, a gate-all-around, a nanosheet FET, or a negative capacitance-nanosheet FET) may be further declared as desired.

A current-voltage model (I-V model) and a capacitance-voltage model (C-V model) may then be computed (lines 4 and 5). The operation of the current-voltage model and the operation of the capacitance-voltage model may be performed sequentially or simultaneously.

In the case of the current-voltage model, at least one hidden layer, for example, two hidden layers, may be generated based on the first artificial neural network 80 (lines 4.1 to 4.4). A weight W\hat{ }1, a bias B\hat{ }1, and an output value A\hat{ }1 corresponding to the first layer 82-1 of the trained first artificial neural network 80 are obtained from the first trained artificial neural network 80, and a node of the first hidden layer of the current-voltage model is generated using the obtained weight W\hat{ }1, bias B\hat{ }1, and output value A\hat{ }1 (line 4.1). The node of the first hidden layer of the current-voltage model may correspond to the first layer 82-1 of the first artificial neural network 80, and may be substantially the same as the first layer 82-1 of the first artificial neural network 80 depending on the situation. At least one activation function is then added for the node of the hidden layer (line 4.2). Here, the activation function may be determined to be the same as the activation function used in the trained first artificial neural network 80, and may include, for example, a hyperbolic tangent function (tanh(A1)). Subsequently, a weight W\hat{ }2, a bias B\hat{ }2, and an output value A\hat{ }2 of the second layer 82-2 of the second artificial neural network 80 may be obtained from the trained second artificial neural network 80, and a node of the second hidden layer of the current-voltage model may be generated based on the obtained weight W\hat{ }2, bias B\hat{ }2, and output value A\hat{ }2 (line 4.3). Similarly, the node of the second hidden layer of the current-voltage model may correspond to the second layer 82-2 of the trained first artificial neural network 80. In this case, the input value of the second hidden layer may be the output value (A\hat{ }1) of the first hidden layer of the current-voltage model. An activation function (e.g., a hyperbolic tangent function (tanh(A2))) may be added to the node of the second hidden layer (line 4.4). In addition, an output layer of the current-voltage model may also be generated corresponding to the output layer of the trained first artificial neural network 80 (line 4.5). The output layer of the current-voltage model may include one node, and the node may be generated using the weight W\hat{ }3, the bias B\hat{ }3, and the output value Y corresponding to the output layer of the first artificial neural network 80. The current-voltage model generated as described above corresponds to the first artificial neural network 80, and may be substantially the same as the first artificial neural network 80. For example, the current-voltage model may be the first artificial neural network 80 converted based on the Verilog-A language.

In the case of the capacitance-voltage model, a predetermined hidden layer is generated based on the second artificial neural network 90 (lines 5.1 to 5.2). In this case, the weight W′\hat{ }1, the bias B′\hat{ }1, and the output value A′\hat{ }1 corresponding to the hidden layer 92 of the trained second artificial neural network 90 are extracted and acquired from the trained second artificial neural network 90, and the hidden layer of the capacitance-voltage model is generated using the weight W′\hat{ }1, the bias B′\hat{ }1, and the output value A′\hat{ }1 (line 5.1). A predetermined activation function such as a hyperbolic tangent function (tanh(A′1)) may be added to the node of the hidden layer (line 5.2). The added activation function may be the same as the activation function of the second artificial neural network 90. The output layer of the capacitance-voltage model may be obtained to correspond to the output layer of the trained second artificial neural network 90 (line 5.3). The node of the output layer of the capacitance-voltage model may be generated using the weight W′\hat{ }2, the bias B′\hat{ }2, and the output value Y_cv corresponding to the output layer of the second artificial neural network 90. The input value for the output layer of the capacitance-voltage model may include an output value A′1 of the hidden layer of the capacitance-voltage model. The capacitance-voltage model generated as described above may be approximately the same as or correspond to the second artificial neural network 90. For example, the capacitance-voltage model may be the second artificial neural network 90 converted into the Verilog-A language.

Referring to FIG. 6, at least one capacitance C_gg, C_gs, C_gd, and C_gb may be calculated (line 6). Here, the at least one capacitance C_gg, C_gs, C_gd, and C_gb may include, for example, a gate capacitance C_gg, a capacitance C_gs (hereinafter, a gate-source capacitance) between the gate and the source 31, a capacitance C_gd (hereinafter, a gate-drain capacitance) between the gate and the drain 32, and a capacitance C_gb (hereinafter, a gate-body capacitance) between the gate and the body. More specifically, for example, the gate capacitance C_gg may be determined by multiplying the number of fins by any one output value Y_CV1 (c_gg(x) of FIG. 4) among the output values of the second artificial neural network 90 (line 6.1), the capacitance C_gs between the gate and the source 31 may be determined by multiplying the number of fins by another output value Y_CV2 (c_gs(x) of FIG. 4) among the output values of the second artificial neural network 90 (line 6.2), and the capacitance C_gd between the gate and the drain 32 may be determined by multiplying the number of fins by another output value Y_CV3 (c_gd(x) of FIG. 4) among the output values of the second artificial neural network 90 (line 6.3). In addition, the gate-body capacitance C_gb may be obtained by subtracting the gate-source capacitance C_gs and the gate-drain capacitance C_gd from the gate capacitance C_gg (line 6.4).

In addition, at least one current I_ds, I_gd, I_gs, and I_gb may also be calculated (line 7). Here, the at least one current I_ds, I_gd, I_gs, and I_gb may include, for example, at least one of a current I_ds between the source 31 and the drain 32, a current I_gd between the gate and the drain 32, a current I_gs between the gate and the source 31, and a current I_gb between the gate and the body. The current I_ds between the source 31 and the drain 32 may be less than the product of the number of fins, the output value, and the voltage between the source 31 and the drain 32 (line 7.1). The current I_gd between the gate and the drain 32 may be less than a value obtained by multiplying the capacitance C_gd (which may be a positive value) between the gate and the drain 32 calculated in the above process (line 6.2) by the time-dependent variation of the voltage between the gate and the drain 32 (line 7.2). The current I_gs between the gate and the source 31 may be given less than a value obtained by multiplying the capacitance C_gs (which may be a positive value. Line 6.3) between the gate and the source 31 calculated in the above process by the time-dependent variation of the voltage between the gate and the source 31 (line 7.3). In addition, the current I_gb between the gate and the body may be given less than a value obtained by multiplying the capacitance C_gb (which may be a positive value. Line 6.4) between the gate and the body by the time-dependent variation of the voltage between the gate and the body (line 7.4).

At least one of a transconductance gm and a drain conductance gds may be calculated (line 8). In this case, the transconductance gm is given as the amount of change in current between the source 31 and the drain 32 according to the change in voltage between the source 31 and the gate (line 8.1), and the drain conductance gds may be given as the amount of change in current between the source 31 and the drain 32 according to the change in voltage between the source 31 and the drain 32 (line 8.2).

A compact model based on the first and second artificial neural networks 80 and 90 is generated by the current-voltage model, the capacitance-voltage model, and at least one value(s) (capacitance, current, transconductance, and/or drain conductance) obtained as described above. Since the generated compact model is implemented using only variables and there is no conditional instruction, etc., it is relatively simply constructed compared to the conventional compact model. Therefore, the analysis of the compact model may be performed more quickly. The generated compact model may be stored in the memory 15, transmitted to another device through the communicator 13 or the output interface 19, or transmitted to the simulator 140 for simulation.

The simulator 140 may perform a simulation on the analysis target using the compact model generated as described above. According to an embodiment, the simulator 140 may be implemented by using a spike and, for example, may perform at least one of a DC simulation, an AC simulation, a transient simulation, and a Monte-Carlo simulation. The simulator 140 may be omitted according to embodiments. In addition, a Gummel symmetry test may be further performed before the simulation according to the selection of a user or a designer.

The above-described apparatus for processing a compact model 10 may be implemented using a device specifically devised to perform processing on at least one of training, modeling, and simulation of the above-described artificial neural network, or may be implemented using one or two or more information processing devices alone or in combination. Here, the one or two or more information processing devices may include, for example, a hardware device for a server, a desktop computer, a laptop computer, a smartphone, a tablet PC, a smart watch, a portable game machine, a navigation device, a remote control device (remote control), a digital television, a set-top box, a media streaming device, a sound reproducing device (artificial intelligence speaker, etc.), a home appliance, an attended or unmanned moving object (vehicle, mobile robot, wireless model vehicle, etc.), an attended or unmanned aerial vehicle (aircraft, multicopter, etc.), a robot (home, industrial, military, etc.), or an industrial machine, but is not limited thereto. A designer, a user, or the like may adopt at least one of other apparatus(es) other than the information processing apparatus as the above-described apparatus for processing a compact model 10 depending on a situation or condition.

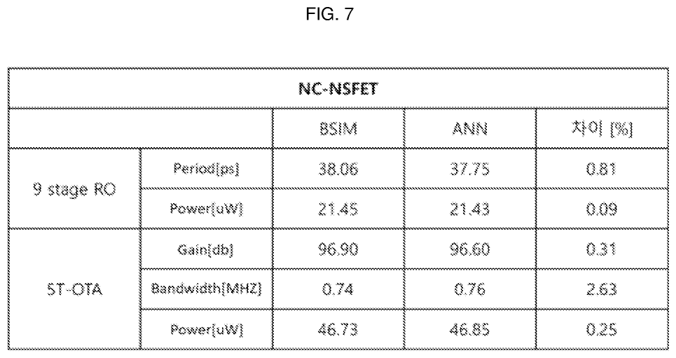

Hereinafter, an effect of the above-described apparatus for processing a compact model will be described with reference to FIGS. 7 to 14.

FIG. 7 is a diagram showing circuit simulation results of the apparatus for processing a compact model according to an embodiment and the conventional BSIM-based simulation apparatus for a negative capacitance-nanosheet FET, wherein an artificial neural network is trained using data of the negative capacitance-nanosheet FET, a compact model is acquired therefrom, and then the acquired compact model and simulation results for each compact model by the conventional BSIM are compared with each other. The simulation was performed by using a 9-stage Ring Oscillator (RO) as a digital circuit and a 5-5T-OTA (5 Transistor Operational Transconductance Amplifier) as an analog circuit.

Referring to FIG. 7, in the case of the 9-stage ring oscillator, a difference between the period and the power is less than 1%, which is substantially the same as the simulation result by the apparatus for processing a compact model and the simulation result by the conventional BSIM-based simulation apparatus described above in relation to the negative capacitance-nanosheet FET. In addition, even in the case of the 5 transistor-op transconductance amplifier, the difference in gain and power was less than 0.5%, which was almost the same. However, when 5 transistor-operation transconductance amplifiers were used, there was a difference of about 2.63% in bandwidth.

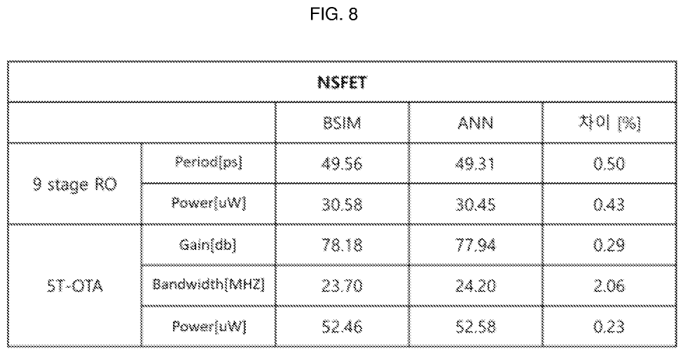

FIG. 8 is a table illustrating circuit simulation results of an apparatus for processing a compact model and a conventional BSIM-based simulation apparatus with respect to a nanosheet FET. FIG. 8 is a diagram illustrating a comparison between simulation results of the acquired compact model and the compact model by the existing BSIM after training the artificial neural network using the data of the nanosheet FET and acquiring the compact model. As described above, the simulation was performed by using a 9-stage ring oscillator as a digital circuit and a 5-transistor-operational transconductance amplifier as an analog circuit.

As shown in FIG. 8, in the simulation result by the apparatus for processing a compact model and the simulation result by the conventional BSIM-based simulation apparatus described above in relation to the nanosheet FET, when the 9-stage ring oscillator is used, the difference between the period is 0.5% and the power difference is 0.43%. That is, the results of both experiments were substantially the same. In addition, even in the case of using the 5 transistor-operation transconductance amplifier, the difference in gain and power was extremely small at 0.29% and 0.23%, respectively. However, similar to the case of the negative capacitance-nanosheet FET, in the case of using the 5 transistor-operational transconductance amplifier, there was a difference of about 2.06% in the bandwidth.

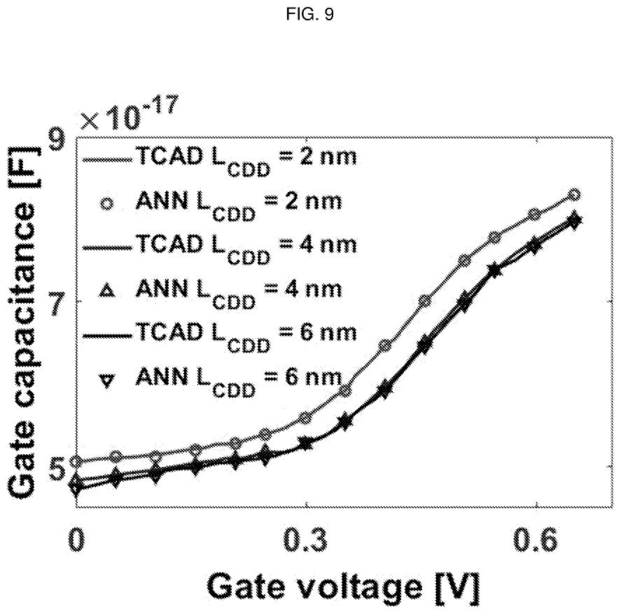

FIG. 9 is a graph illustrating an example of a C-V curve obtained according to a plurality of process parameters, in which an analysis target is a negative-capacitance nanosheet FET, and process parameters are C-V curves obtained from situations respectively given as 2 nm, 4 nm, and 6 nm. In FIG. 9, lines represent a case of using TCAD, and circle, triangle, and inverse triangle represent a case of using the above-described artificial neural network.

Referring to FIG. 9, it can be seen that the C-V curve obtained using the compact model using the artificial neural network has substantially the same value or slope as the C-V curve when the TCAD is used, even if the process parameters are different. The error between them is generally less than 1%, indicating that the compact model using the artificial neural network above has quite high accuracy. For example, it can be seen that the compact model using such an artificial neural network can be generated within a relatively shortened time compared to the prior art, and thus has excellent effects in terms of time and economy.

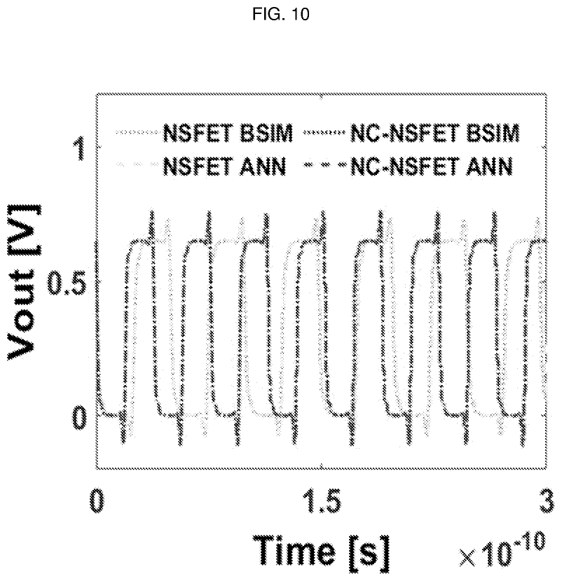

FIG. 10 is a graph illustrating comparison results between transient simulation results of an apparatus for compact model processing according to an embodiment and a ring oscillator according to the related art. Here, BSIM has been used as a conventional technology.

As shown in FIG. 10, it can be seen that the change in the output voltage over time obtained by the 17-stage ring oscillator transient simulation by the above-described apparatus for processing a compact model is mostly consistent with the change in the output voltage over time obtained as a result of the 17-stage ring oscillator transient simulation by the BSIM, the maximum/minimum magnitude of the voltage, the change time point of the voltage, and the change form for both the nanosheet FET and the negative capacitance nanosheet FET. In other words, it can be seen that the apparatus for processing the compact model described above in relation to the ring oscillator transient simulation can achieve high accuracy.

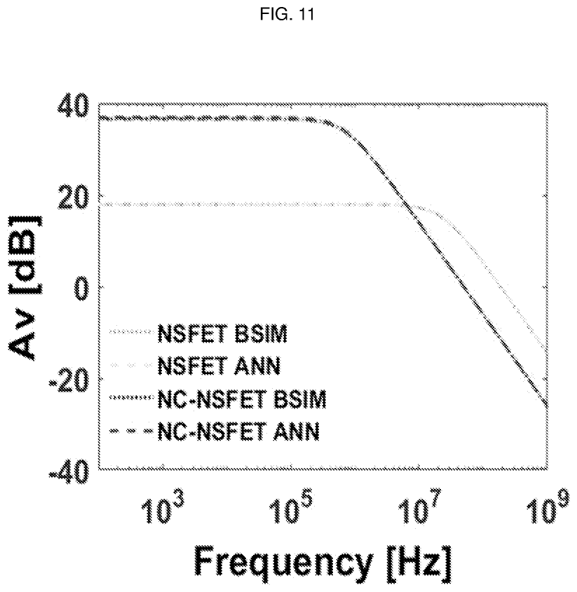

FIG. 11 is a graph illustrating a comparison between simulation results of an apparatus for processing a compact model according to an embodiment and a five transistor OTA according to the related art. Here, BSIM was used as the related art.

Referring to FIG. 11, it can be seen that the simulation results of the 5 transistor-operational transconductance amplifier based on the apparatus for processing a compact model are substantially identical to the simulation results of the 5 transistor-operational transconductance amplifier based on the BSIM for both the nanosheet FET and the negative capacitance nanosheet FET. In other words, it can be seen that the apparatus for processing a compact model has high accuracy even in relation to the simulation of the 5 transistor-operational transconductance amplifier.

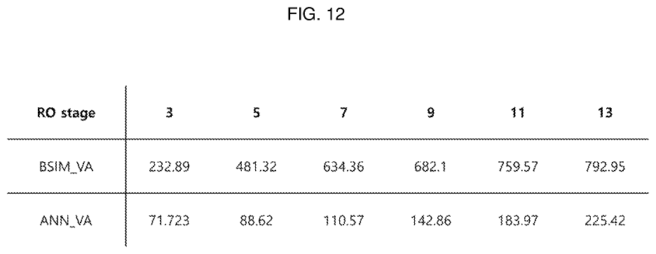

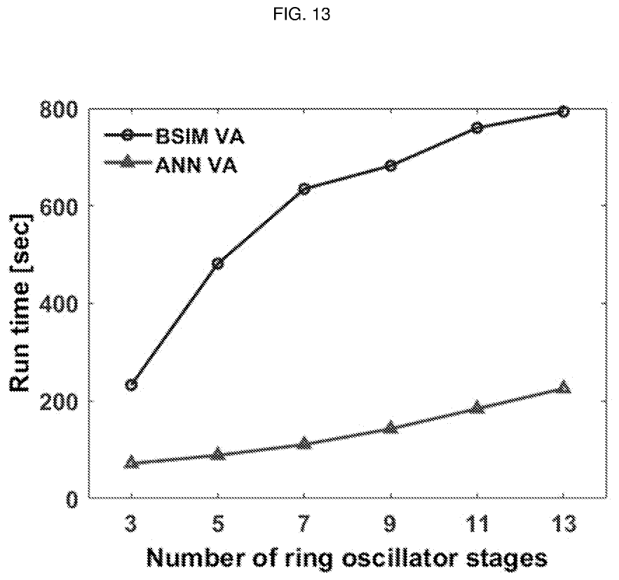

FIG. 12 is a diagram illustrating a comparison result of simulation processing times by the apparatus for processing a compact model according to an embodiment and the related art, and illustrates a comparison result of processing times according to the number of ring oscillator stages. FIG. 13 is a view illustrating a comparison result of simulation processing times by the apparatus for processing a compact model according to an embodiment and the related art in the form of a graph. Here, BSIM was used as the related art. In FIG. 13, the x-axis means the number of ring oscillator stages, and the y-axis means time (sec).

Referring to FIGS. 12 and 13, when the number of ring oscillator stages is 3, 5, 7, 9, 11, and 13, the processing time of the BSIM-based simulation is 232.89 sec, 418.32 sec, 634.36 sec, 682.1 sec, 759.57 sec, and 792.95 sec, and it can be seen that the number of ring oscillator stages increases significantly rapidly according to the increase in the number of ring oscillator stages. On the other hand, the processing time of the simulation according to the above-described artificial neural network-based compact model is 71.723 seconds, 88.62 seconds, 110.57 seconds, 142.86 seconds, 183.97 seconds, and 225.42 seconds, respectively, in the case of 3, 5, 7, 9, 11, and 13 ring oscillator stages, which is much lower than the processing time of the BSIM-based simulation, and the increase width thereof is relatively smaller than that of the BSIM-based simulation. Therefore, it can be seen that the apparatus for processing a compact model has high accuracy, as described above, and may perform the simulation much more rapidly than the related art.

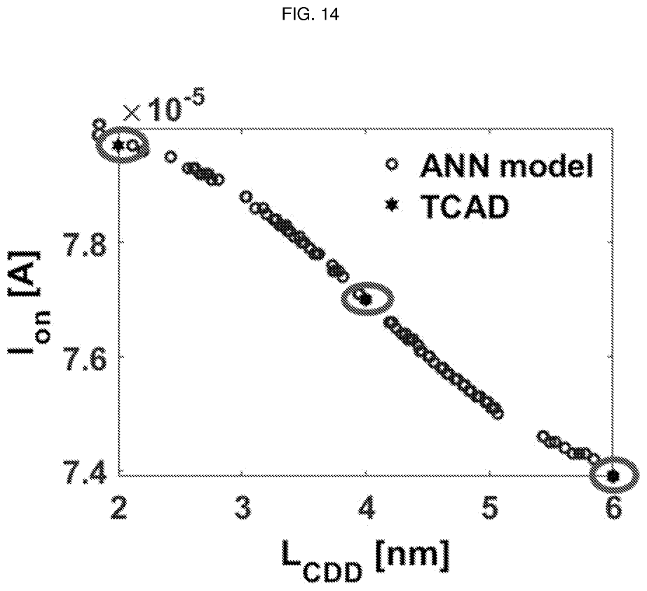

FIG. 14 is a graph illustrating on-current distribution according to a channel doping depth.

As shown in FIG. 14, in the case of using the above-described artificial neural network-based compact model, the value of the on-current according to the length of the channel doping region is substantially inversely proportional to each other, and substantially matches the value of the on-current according to the length of the channel doping region in the case of using the TCAD. Therefore, the artificial neural network-based compact model appropriately reflects the change in current according to the length of the channel doping region, which has an effect of further improving the accuracy of the simulation for the analysis target.

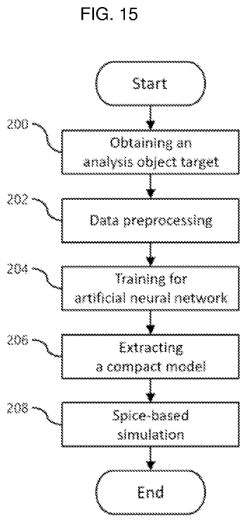

Hereinafter, an embodiment of a method for processing a compact model will be described with reference to FIG. 15.

FIG. 15 is a flowchart of a method for processing a compact model according to an embodiment.

As shown in FIG. 15, when a user or a designer provides information on an analysis target, the analysis target may be obtained in response to the information (200). The analysis target may include, for example, a MOSFET, a FinFET, a gate-all-around, a nanosheet FET, a negative capacitance-nanosheet FET, or the like. The information on the analysis target may include information on the structure or configuration of the analysis target, and may include, for example, but is not limited to, at least one of the overall structure of the semiconductor device, each part, numerical values (width, depth, or width) for the size of each part, and materials of each part. When information on the analysis target is given, the analysis target is virtually generated in a two-dimensional or three-dimensional format by combining them. The analysis target acquisition process (200) may be omitted according to an embodiment, and in this case, the information on the analysis target provided by the user or the designer may be used as an input parameter for the artificial neural network. According to an embodiment, the information on the analysis target may be used as an input parameter after data preprocessing is performed.

Data preprocessing may be performed for the training of the artificial neural network (202). The data preprocessing may be performed on the information on the analysis target. Accordingly, an input parameter to be input to the artificial neural network is obtained. Here, the input parameter may include all or part of the information on the analysis target. For example, the input parameter may include at least one of a geometry parameter, a process parameter, a temperature, and a bias. Here, the geometric parameter may include five key parameters such as a gate length, a width of a nanosheet, a thickness of a nanosheet, a thickness of a spacer, and a thickness of a ferroelectric material. The process parameter is a process-based variable and may include a channel doping depth and the like. The data preprocessing may include, for example, data scaling such as min-max scaling or log scaling. The data preprocessing process 202 may be omitted according to an embodiment, and in this case, the information on the analysis target directly provided by the user or the designer may be used as the input parameter as it is, or the information on the analysis target obtained according to the information combination as described above may be used as the input parameter.

Training for the artificial neural network may be performed based on the input parameter (204). Here, the trained artificial neural network may include, for example, a first artificial neural network corresponding to the current-voltage model and a second artificial neural network corresponding to the capacitance-voltage model. The first artificial neural network includes an input layer, a hidden layer, and an output layer, and the hidden layer may include two hidden layers sequentially connected. Each hidden layer may include at least one node connected to each other layer, for example, each 10 nodes. As an input value of the input layer, the above-described input parameters (geometry parameter, process parameter, temperature, and/or bias) may be used. In addition, as the output value of the output layer, a current transmitted to the drain when a voltage is applied may be used. The second artificial neural network may include an input layer, a hidden layer, and an output layer. The input value of the input layer of the second artificial neural network may include the above-described input parameters (geometry parameter, process parameter, temperature and/or bias, etc.), and the output value of the output layer may include capacitance (gate capacitance, gate-source capacitance, gate-drain capacitance, etc.). As the activation function of each node of the first and second artificial neural networks, at least one of a hyperbolic tangent function, a sigmoid function, a step function, and a ReLU function may be adopted. The first artificial neural network and the second artificial neural network may be implemented using the same or the same kind of artificial neural network according to embodiments, or may be implemented using different artificial neural networks. Here, the artificial neural network may include, for example, any one of a deep neural network, a convolutional neural network, a convolutional recurrent neural network, a multilayer perceptron, a deep trust neural network, and a deep Q-network, but is not limited thereto. Meanwhile, at least one of the first and second artificial neural networks described above may be expressed by Equation 1 described above. In addition, the loss function for at least one of the first and second artificial neural networks described above may be given as the weighted sum of the square mean for the error of the measured value and the predicted value for each of the blocking region, the linear region, and the saturation region as shown in Equation 2.

A compact model may be extracted and acquired using the trained artificial neural network (206). For example, the compact model may be obtained by automatically extracting a desired parameter from an artificial neural network that has completed training, and generating a code using the Verilog-A language using the extracted parameter. The extraction and acquisition of the compact model may be performed by excluding condition instructions as much as possible using a vectorization technique, or may be performed using only variables without arrangement.

According to an embodiment, an analysis target is first determined for extracting and obtaining a compact model, and at least one variable for generating the compact model is declared and generated. The declared and generated variable may include, for example, at least one of a variable for a value extracted from the artificial neural network (a weight of each artificial neural network, a bias, and an output value of each hidden layer), a variable for an input value, a variable for an output value, and a variable for the number of fins. Subsequently, a current-voltage model and a capacitance-voltage model are generated based on the input value of the input layer, the weight of the hidden layer, the bias of the hidden layer, the output value of the hidden layer, the output value of the output layer, and the activation function obtained from the trained artificial neural network, respectively. In addition, at least one capacitance (gate capacitance, gate-source capacitance, gate-drain capacitance, and/or gate-body capacitance, etc.), at least one current (current between the source and the drain, current between the gate and the drain, current between the gate and the source, and/or current between the gate and the body, etc.), transconductance, drain conductance, etc. may be further calculated. The compact model may be extracted and generated based on the current-voltage model, the capacitance-voltage model, and the calculated value(s) (at least one capacitance, at least one current, transconductance, and/or drain conductance), and may be generated by combining them.

When the compact model is extracted and generated, a simulation for the analysis target may be performed based on the compact model according to the embodiment (208). The simulation may include a spice-based simulation. For example, the spice-based simulation may include at least one of a DC simulation, an AC simulation, a transient simulation, and a Monte-Carlo simulation. The simulation performing process 208 for the analysis target may be omitted. According to an embodiment, it is also possible that a Gumel symmetry experiment is further performed in connection with the compact model before or simultaneously with the simulation on the analysis target.

According to the above-described embodiment, the compact model processing method may be implemented as a program capable of being driven by a computer device. A program may include instructions, a library, a data file, and/or a data structure alone or in combination, and it may be designed and produced using machine language codes or advanced language codes. The program may be specifically designed to implement the above-described method, or may be implemented using various functions or definitions already known and usable by those skilled in the art in the computer software field. In addition, here, the computer device may be implemented by including a processor or a memory capable of realizing a function of a program, and may further include a communication device as necessary. A program for implementing the above-described compact model processing method may be recorded on a recording medium readable by a device such as a computer. Computer-readable recording media may include, for example, semiconductor storage media such as ROM, RAM, SD card or flash memory (e.g., solid state drive (SSD), magnetic disk storage media such as hard disk or floppy disk, optical recording media such as compact disk or DVD, or at least one type of physical storage media that can temporarily or non-temporarily store one or more programs executed at the call of a device such as a computer, such as a flexible disk.

Although various embodiments of the above apparatus and method for processing a compact model have been described, the apparatus and method for processing a compact model are not limited to the above-described embodiments. Other various apparatus or methods that may be modified and modified based on the above-described embodiments by a person skilled in the art may also be one embodiment of the above-described apparatus and method for processing a compact model. For example, even if the described method(s) are performed in a different order than described, and/or component(s) such as system, structure, device, circuit, etc. described are combined, connected or combined or combined or replaced or substituted by other component or equivalent in a different form than described, It may be an embodiment of the above-described apparatus and/or method for processing a compact model.

The apparatus for processing the compact model 10, the input interface 11, the communicator 13, the memory 15, the output interface 19, the processor 100 described herein, including descriptions with respect to respect to FIGS. 1-15, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-15 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations).

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-Res, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

According to the above-described apparatus and method for processing a compact model, it is possible to generate an artificial neural network-based compact model that enables rapid execution of a simulation test with high accuracy while conforming to a complex analysis target.

According to the above-described apparatus and method for processing a compact model, a designer or a user can easily add a desired variable such as a variable related to a process when generating the compact model, thereby improving the accuracy and expandability of the compact model and upgrading the same.

According to the above-described apparatus and method for processing a compact model, it is possible to obtain a compact model that can be easily used in next-generation devices such as a nanosheet FET (NSFET), a negative capacitance nanosheet FET (NC-NSFET), and the like.

According to the above-described apparatus and method for processing a compact model, the compact model may be constructed to be relatively lightweight, and thus, the generation of the compact model and the derivation of a parameter from the compact model may be more rapidly processed.

According to the above-described apparatus and method for processing a compact model, a simulator such as a Simulation Program with Integrated Circuit Emphasis (SPICE) may perform a simulation on a semiconductor device corresponding to the compact model with relatively high accuracy and high speed.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An apparatus comprising:
one or more processors configured to:
train an artificial neural network for an analysis target including at least one of a first artificial neural network corresponding to a current-voltage model and a second artificial neural network corresponding to a capacitance-voltage model by using a geometric parameter and a process parameter as an input value; and
extract a compact model by determining any one or any combination of any two or more of a current-voltage model corresponding to the trained first artificial neural network and a capacitance-voltage model corresponding to the trained second artificial neural network based on an input value of an input layer, a weight of a hidden layer, a bias of the hidden layer, an output value of the hidden layer, an output value of the output layer, and an activation function obtained from the trained first artificial neural network and the trained second artificial neural network.

2. The apparatus of claim 1,
wherein the analysis target comprises a field effect transistor having at least one channel, and
wherein the process parameter comprises a channel doping depth that is a depth at which ions are implanted into the field effect transistor channel.

3. The apparatus of claim 2,
wherein the field effect transistor comprises either one or both of a nanosheet FET and a negative capacitance nanosheet FET, and
wherein the geometric parameter comprises any one or any combination of any two or more of a gate length, a width of a nanosheet, a thickness of the nanosheet, a thickness of a spacer, and a thickness of a ferroelectric material of the nanosheet FET and the negative capacitance nanosheet FET.

4. The apparatus of claim 1,
wherein the loss function of the artificial neural network is a weighted sum of a mean square of error between the measured value of the blocked region and the predicted value, a mean square of error between the measured value of the linear region and the predicted value, and a mean square of error between the measured value of the saturated region and the predicted value.

5. The apparatus of claim 1,
wherein the one or more processors are further configured to calculate any one or any combination of any two or more of at least one capacitance, at least one current, transconductance, and drain conductance and generate a compact model by combining either one or both of a current-voltage model corresponding to the trained first artificial neural network and a capacitance-voltage model corresponding to the trained second artificial neural network with any one or any combination of any two or more of the at least one capacitance, the at least one current, the transconductance, and the drain conductance.

6. The apparatus of claim 5,
wherein the capacitance comprises any one or any combination of any two or more of a gate capacitance, a gate-source capacitance, a gate-drain capacitance, and a gate-body capacitance, and
wherein the one or more processors calculate the capacitance by multiplying the number of fins by one output value among output values of the second artificial neural network.

7. The apparatus of claim 6,
wherein the current comprises any one or any combination of any two or more of a current between a gate and a drain, a current between a gate and a source, and a current between a gate and a body, and
wherein the one or more processors are configured to calculate the current based on a value obtained by multiplying the calculated capacitance by a variation of a voltage over time.

8. The apparatus of claim 1,
further comprising:
a simulator configured to perform a simulation for the analysis target based on the compact model.

9. The apparatus of claim 1, further comprising a memory storing instructions,
wherein the one or more processors are configured to execute the instructions to configure the one or more processors to perform the training of the artificial neural network, and perform the extraction of the compact model.

10. A processor-implemented method comprising:
training an artificial neural network for an analysis target including either one or both of a first artificial neural network corresponding to a current-voltage model and a second artificial neural network corresponding to a capacitance-voltage model by using obtained geometric parameter and obtained process parameter as an input value to obtain at least one trained artificial neural network; and
extracting a compact model by determining any one or any combination of any two or more of a current-voltage model corresponding to the trained first artificial neural network and a capacitance-voltage model corresponding to the trained second artificial neural network based on an input value of an input layer, a weight of a hidden layer, a bias of the hidden layer, an output value of the hidden layer, an output value of the output layer, and an activation function obtained from the trained first artificial neural network and the trained second artificial neural network.

11. The method of claim 10,
wherein the analysis target comprises a field effect transistor having at least one channel, and
wherein the process parameter comprises a channel doping depth that is a depth at which ions are implanted into the field effect transistor channel.

12. The method of claim 11,
wherein the field effect transistor comprises either one or both of a nanosheet FET and a negative capacitance nanosheet FET, and
wherein the geometric parameter comprises any one or any combination of any two or more of a gate length, a width of a nanosheet, a thickness of the nanosheet, a thickness of a spacer, and a thickness of a ferroelectric material of the nanosheet FET and the negative capacitance nanosheet FET.

13. The method of claim 10,
wherein the loss function of the artificial neural network is a weighted sum of a mean square of error between the measured value of the blocked area and the predicted value, a mean square of error between the measured value of the linear area and the predicted value, and a mean square of error between the measured value of the saturated area and the predicted value.

14. The method of claim 10,
Wherein the extracting of the compact model comprises:
calculating any one or any combination of any two or more of at least one capacitance, at least one current, transconductance, and drain conductance; and
generating the compact model by combining either one or both of a current-voltage model corresponding to the trained first artificial neural network and a capacitance-voltage model corresponding to the trained second artificial neural network with any one or any combination of any two or more of the at least one capacitance, the at least one current, the transconductance, and the drain conductance.

15. The method of claim 14,
wherein the capacitance comprises any one or any combination of any two or more of a gate capacitance, a gate-source capacitance, a gate-drain capacitance, and a gate-body capacitance, and
wherein the extracting of the compact model is configured to calculate the capacitance by multiplying the number of fins by any one output value among output values of the second artificial neural network.

16. The method of claim 15,
wherein the current comprises any one or any combination of any two or more of a current between a gate and a drain, a current between a gate and a source, and a current between a gate and a body, and
wherein the extracting of the compact model is configured to calculate the current based on a value obtained by multiplying the calculated capacitance by a variation of a voltage over time.

17. The method of claim 16,
wherein the transconductance is an amount of current change between a source and a drain according to a change in voltage between the source and the gate, and
wherein the drain conductance is an amount of current change between the source and the drain according to a change in voltage between the source and the drain.

18. The method of claim 10,
further comprising:
performing a simulation for the analysis target based on the compact model.

19. A non-transitory computer-readable storage medium storing instructions that, when executed by the one or more processors, configure the one or more processors to perform the method of claim 10.
